(19) United States
(12) Patent Application Publication
(10) Pub. No.: US 2015/0196932 A1
(43) Pub. Date: Jul. 16, 2015

(54) Epoxy and Paint Roller

(71) Applicant: Michael Carlson, Aztec, NM (US)

(72) Inventor: Michael Carlson, Aztec, NM (US)

(21) Appl. No.: 14/597,173

(22) Filed: Jan. 14, 2015

Related U.S. Application Data
(60) Provisional application No. 61/927,290, filed on Jan. 14, 2014.

(51) Int. Cl. B05C 17/02; B25G 1/06

(52) U.S. Cl. CPC B05C 17/022; B25G 1/06

(57) ABSTRACT

An epoxy and paint roller is disclosed. The present invention includes an elongated handle having a distal end and a working end. The working end is pivotally attached to a roller support having a roller rotatably attached thereto. In one embodiment, the working end includes a knuckle joint that is aligned with a closed loop that is centrally disposed on the roller support so as to receive a fastener therethrough. The handle can be pivoted from one side of the roller to the opposite side thereof so that the handle is substantially parallel to the roller support. Alternatively, the handle can be positioned perpendicular to the roller support so that the present epoxy and paint roller can be used in a usual manner.

### CROSS REFERENCE TO RELATED APPLICATION

This application claims the benefit of U.S. Provisional Application No. 61/927,290 filed on Jan. 14, 2014. The above identified patent application is herein incorporated by reference in its entirety to provide continuity of disclosure.

### FIELD OF THE INVENTION

The present invention relates to a rolling device for paint, epoxy, and other types of resin. More specifically, the present invention pertains to an improved epoxy and paint roller that can be pivoted to be used at different angles.

### BACKGROUND OF THE INVENTION

Epoxy coating is applied to floors to resist stains, and to protect a floor while providing a finished appearance. Applying an epoxy coating to a concrete floor requires the use of proper tools, such as epoxy rollers. Epoxy rollers are hand tools used for painting large flat surfaces rapidly and efficiently. Epoxy rollers generally comprise a roller frame and a roller attached thereto. Traditionally, the roller frame is rigid and is configured so that the roller can only move back and forth in one direction.

An epoxy coating must be applied uniformly so as to provide an even appearance and to provide a flat surface. This requires a user to roll epoxy coating in various directions and angles to ensure that the coating is spread over the entire surface area of the floor. Rolling epoxy coating in various directions and angles, however, require individuals to adjust their grip on the epoxy roller, which can be inconvenient as some individuals may prefer to work with their dominant hand.

Alternatively, individuals must move in different directions while on the floor or they are required to work in teams so as to cover all areas of the floor. Moving excessively on the floor while applying epoxy coating is not ideal, because the individuals risk accidentally stepping onto the wet epoxy coating or running into one another. Thus, a device that enables an individual to coat epoxy, paint or a similar substance in a uniform and efficient manner without requiring assistance from another individual is desired.

### DESCRIPTION OF THE PRIOR ART

Devices have been disclosed in the prior art that claim rollers for paint and other types of coatings. These include devices that have been patented and published in patent application publications. These devices generally disclose a roller with a swiveling roller head. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,849,550 to Lanz discloses a roller frame having an elongated neck extending therefrom. The elongated neck comprises a handle pivotally attached thereto. The handle is bent at an angle relative to the elongated neck, so that the handle does not contact the neck when pivoting. Lanz, however, does not disclose a handle and a roller support connected via a knuckle joint.

U.S. Pat. No. 8,273,002 to Tipu and U.S. Pat. No. 8,060,975 to Williams disclose paint roller frames having a handle connected thereto via a joint. The joint may comprise a cylindrical joint or a ball joint such that the handle can be pivoted side to side or up and down. The foregoing devices, however, do not disclose a knuckle joint that allows the handle to rotate in a single plane, such that the handle can pivot between opposing sides of the roller support.

Finally, U.S. Pat. No. 5,903,952 to Camp and U.S. Pat. No. 5,207,755 to Ampian disclose paint rollers having multiple joints between the roller frame and the handle. In this way, the roller head and the handle can be moved independently of each other. Thus, Camp and Ampian do not disclose an epoxy and paint roller that comprises a knuckle joint, wherein the knuckle joint is adapted to allow a user to position the roller head at various angles. Additionally, the foregoing devices do not disclose a handle that can be adjusted in length.

The devices disclosed in the prior art have several known drawbacks. These devices are limited in that they are generally designed for use with smaller paint rollers. Additionally, these devices are not configured so that the handle can move in a single plane from one side of an axis of the roller to the other side of the axis of the roller. The present invention overcomes these limitations by disclosing an epoxy and paint roller having a handle with a roller support pivotally attached thereto via a knuckle joint. The handle is adapted to pivot so that it can move side to side. In this way, the present invention allows the roller to move in various angles without requiring the user to adjust his or her grip on the handle.

It is therefore submitted that the present invention is substantially divergent in design elements from the prior art, and consequently it is clear that there is a need in the art for an improvement to rollers for paint and other types of coatings. In this regard, the instant invention substantially fulfills these needs.

### SUMMARY OF THE INVENTION

In view of the foregoing disadvantages inherent in the known types of rollers for paint and other types of coatings now present in the prior art, the present invention provides a new and improved epoxy and paint roller wherein the same can be utilized for applying epoxy and paint on a surface. In one embodiment, the present invention comprises an elongated handle having a distal end and a working end. The working end includes a roller support pivotally attached thereto via a knuckle joint and a fastener. In this way, the handle can pivot in a single plane.

Additionally, the handle can be positioned so that it is perpendicular to the roller support, allowing the user to use the epoxy and paint roller of the present invention in a usual manner. The roller support comprises a roller rotatably attached thereto. The roller may comprise various types of rollers, including foam rollers, nap rollers, or other such rollers. Thus, the present invention can be used to apply epoxy, paint or other types of coating, increasing versatility to the user.

It is therefore an object of the invention to provide a new and improved epoxy and paint roller that has all of the advantages of the prior art and none of the disadvantages.

Another object of the present invention is to provide a new and improved epoxy and paint roller that can move up and down and side to side without requiring a user to adjust his or her grip.

Yet another object of the present invention is to provide a new and improved epoxy and paint roller that can be adjusted in length.

Still yet another object of the present invention is to provide a new and improved epoxy and paint roller that can be used with various types of rollers.

Still yet another object of the present invention is to provide a new and improved epoxy and paint roller wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of a first embodiment of the present invention.

FIG. 2 shows a close up side view of a first embodiment of the present invention.

FIG. 3 shows a close up front view of a first embodiment of the present invention.

FIG. 4 shows another close up front view of a first embodiment of the present invention.

FIG. 5 shows a close up front view of a second embodiment of the present invention.

FIG. 6 shows a close up front view of a third embodiment of the present invention.

FIG. 7 shows another close up front view of a third embodiment of the present invention.

### DETAILED DESCRIPTION OF THE INVENTION

References are made herein to the attached drawings. Like reference numerals are used throughout the drawings to depict like or similar elements of the epoxy and paint roller. For the purposes of presenting a brief and clear description of the present invention, the preferred embodiment will be discussed as used to apply epoxy and paint on a surface. The figures are intended for representative purposes only and should not be considered to be limiting in any respect.

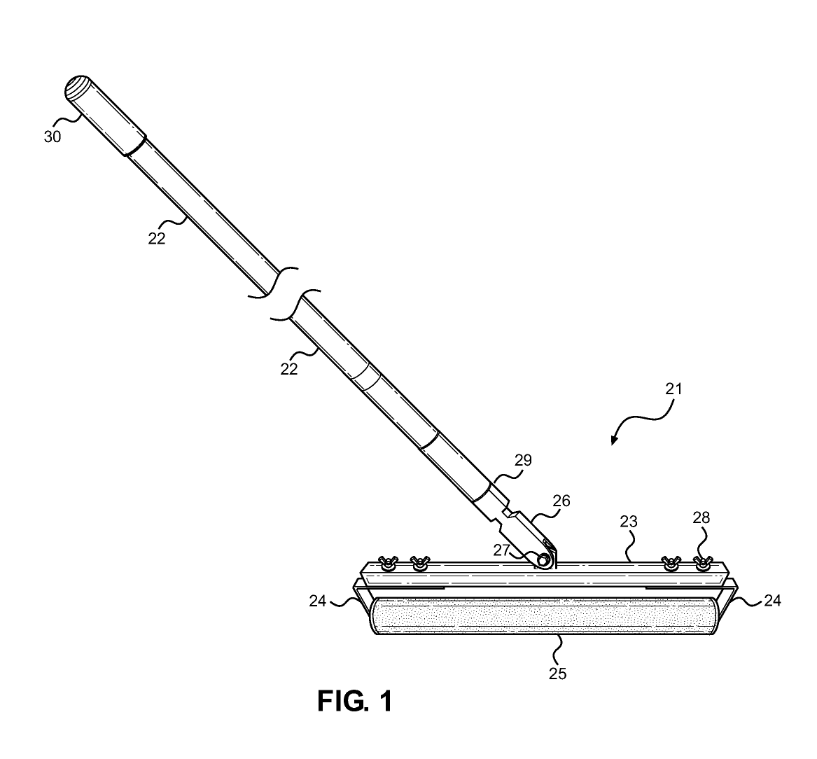

Referring now to FIG. 1, there is shown a perspective view of the first embodiment of the present invention. The present epoxy and paint roller 21 comprises an elongated handle 22 with a distal end 30 and a working end 29. The working end 29 comprises a roller support 23 and a cylindrical roller 25 rotatably attached thereto. The handle 22 is adjustable in length so that it can be shortened or lengthened as desired by the user. It is contemplated that the handle 22 can be lengthened to reach high elevations or longer distances. Conversely, the handle 22 can be shorted to increase the control of the movement of the roller 25. In one embodiment, the handle 22 can be separated into multiple sections and removably connected together. The sections can be connected via press fit or threadably attached. Alternatively, a first end of each of the sections may comprise an aperture and a second end of each of the sections may comprise a spring biased button. The spring biased button is configured to be inserted into the aperture disposed on the first end of an adjacent section. In another embodiment, the handle 22 comprises a telescopic construction so that the handle 22 can be extended and retracted.

The working end 29 comprises a knuckle joint 26 that is pivotally connected to the roller support 23 via a fastener 27. The knuckle joint 26 is structurally integral to the working end 29 of the handle 22 or is press fitted thereto. In the illustrated embodiment, the fastener 27 comprises a bolt and a wing nut, but alternate fasteners may be used in other embodiments. The roller support 23 has a rectangular shape with a defined upper side and an underside. In the illustrated embodiment, the roller support 23 comprises a brace 24 at each of the ends thereof. The brace 24 comprises a first section that is perpendicular to a second section to form an L-shape when viewed from the side. The first section of the brace 24 is attached to the underside of the roller support 23 via fasteners 28 such as bolts or screws. The second section of each brace 24 extends downward and rotatably connects to the ends of the roller 25. As such, it is contemplated that each end of the roller 25 comprises an axle or a similar rotatable connection.

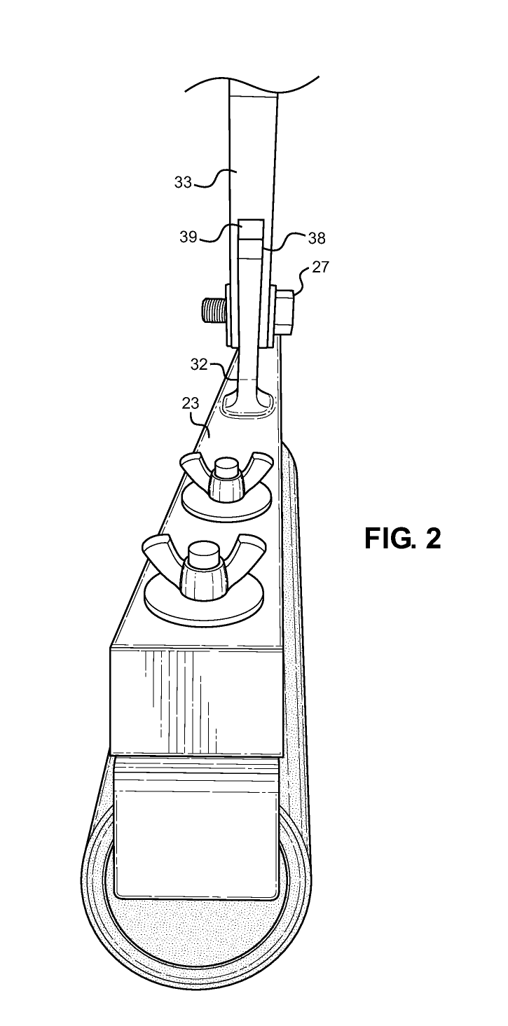

Referring now to FIG. 2, there is shown a close up side view of the present invention. The roller support 23 includes a closed loop 32 centrally located thereon, wherein the loop 32 comprises circular opening. The loop 32 may be welded so that it is integral to the upper side of the roller support 23. The loop 32 is aligned with the opening on a pair of protruding members 33 of the knuckle joint. The protruding members 33 comprise a first protruding member and a second protruding member that extend downward from the knuckle joint. The first and second protruding members 33 are separated by a gap so as to hold the loop 32 therebetween. In this way, the opening on the loop 32 and the opening on each of the protruding members 33 form a single opening that is adapted to receive the fastener 27 therethrough. In the present invention, the fastener 27 comprises a bolt having a wing nut secured thereon.

The loop 32 and the protruding members 33 of the knuckle joint 26 are pivotally attached so that in a first position, the handle is perpendicular to the roller support 23, and in a second position, the handle is moved to the one side of a vertical axis. In this way, the handle can be oriented so that it is substantially parallel to the roller support 23. When the handle is in the first position, the roller can be rolled up and down. When the handle is in the second position, the roller can be rolled side to side. Thus, the present invention allows the user to move the roller side to side or up and down without adjusting his or her grip.

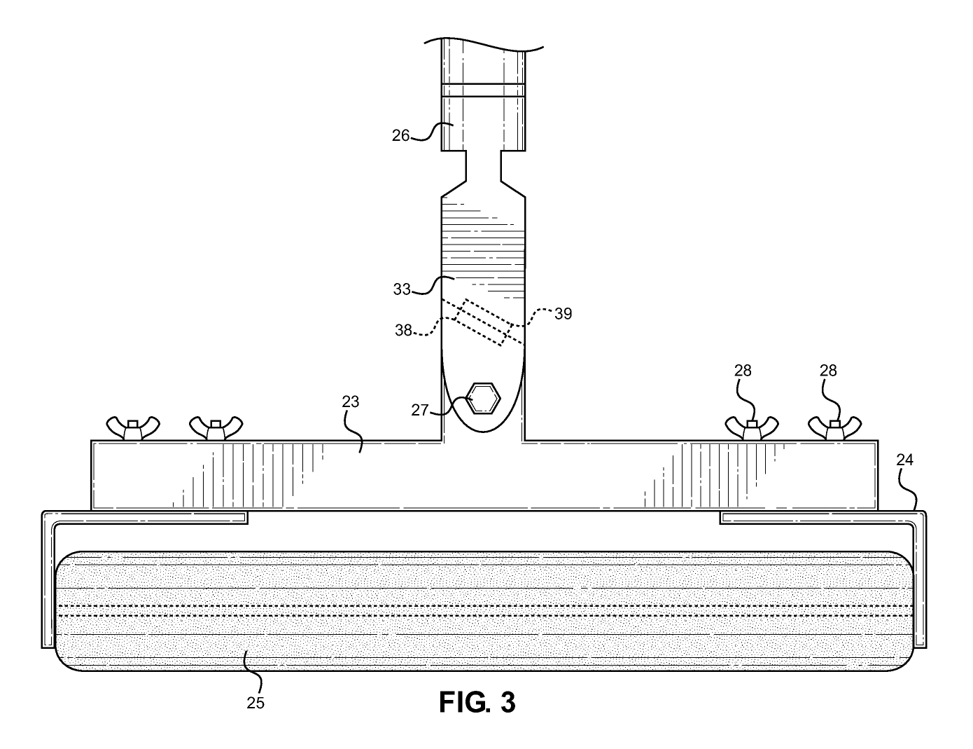

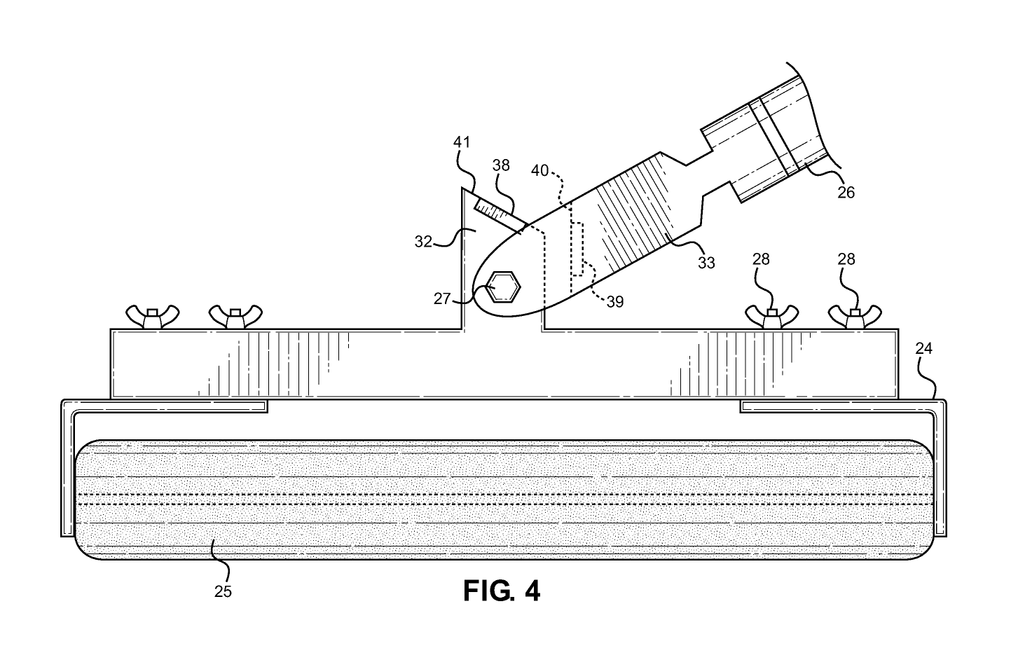

Referring now to FIGS. 3 and 4, there are shown close up front views of the first embodiment of the present invention. The protruding members 33 of the knuckle joint 26 can be secured in place via magnets. The loop 32 comprises a first magnet 38 on a slanted upper edge 41 thereof. The first magnet 38 is located so that it is directly aligned with a second magnet 39 on a slanted edge 40 disposed between the protruding members 33. The slanted edges 40, 41 are configured so as to directly rest against each other. Additionally, the slanted edges 40, 41 prevent the handle from rotating from one side of the axis of the roller to the opposite side of the axis of the roller. When the first magnet 38 directly contacts the second magnet 39, the loop 32 and the knuckle joint 26 are vertically aligned so as to temporarily lock the handle in a vertical position, such that it is perpendicular to the roller support 23. The first magnet 38 and the second magnet 39 can thereafter be detached so that the knuckle joint 26 can pivot as desired by the user.

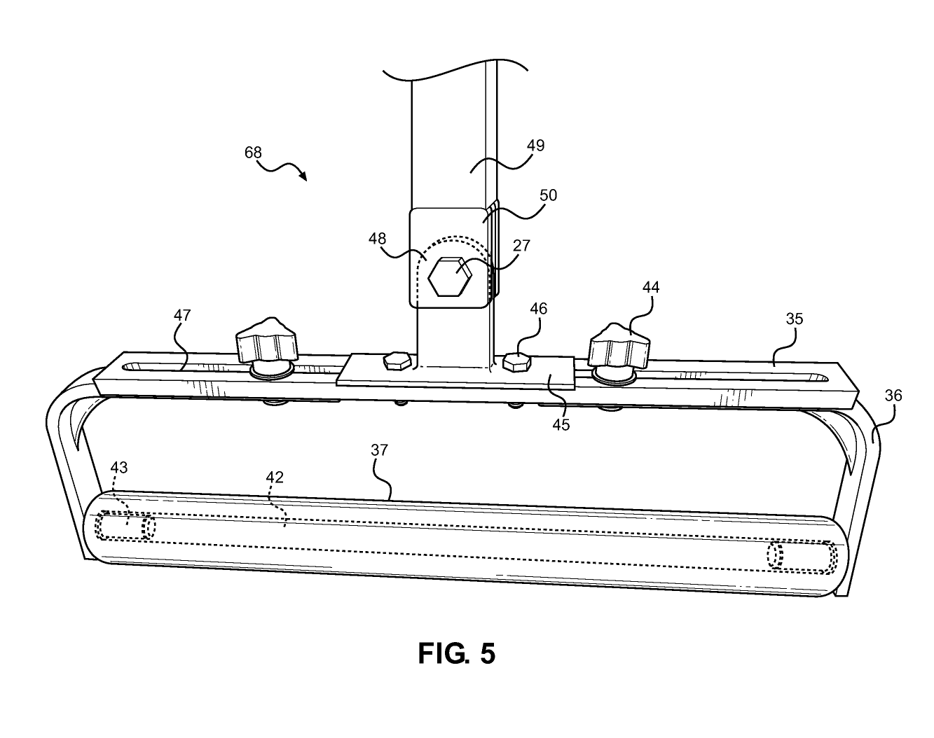

Referring now to FIG. 5, there is shown a close up front view of a second embodiment of the present invention. The illustrated embodiment of the epoxy and paint roller 68 comprises a roller support 35 a pair of channels 47 thereon. Each channel 47 is adapted to guide a fastener 44 that is attached to an L-shaped brace 36. The fastener 44 comprises a bolt or similar fastener that can be loosened or tightened via threaded elements or the like. In this way, the L-shaped brace 36 can extend outward or inward to accommodate rollers 37 of various length. Each L-shaped brace 36 is adapted to support the roller 37 thereon via a tab 43 that is configured to removably insert into the hollow cavity 42 of the roller 37.

The roller support 35 further comprises a plate 45 having a closed loop 48 extending upward therefrom. The plate 45 is centrally located on the roller support 35 and secured thereto via fasteners 46 such as screws. The closed loop 48 comprises an opening that can be aligned with openings on the protruding members 50 of the knuckle joint 49 so as to receive a fastener 27 therethrough. The knuckle joint 49 is pivotally attached to the working end of the handle. The handle can be pivot about the joint in a single plane so as to allow the user to move the roller side to side. In this way, the handle can rotate 180 degrees. Alternatively, the handle can be centered so that it is perpendicular to the roller support 35, allowing the user to move the roller up and down.

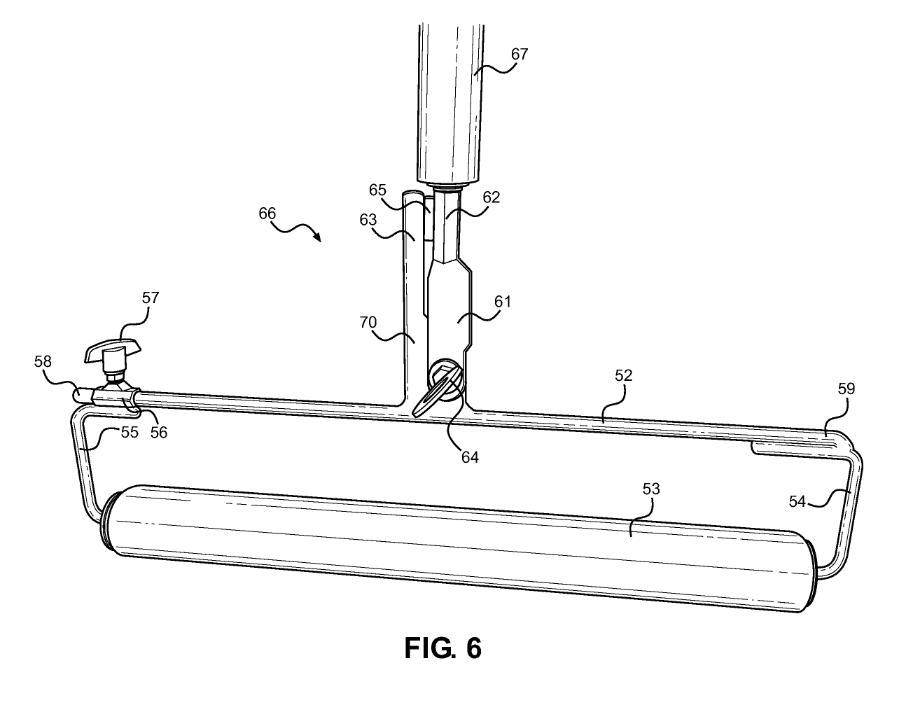

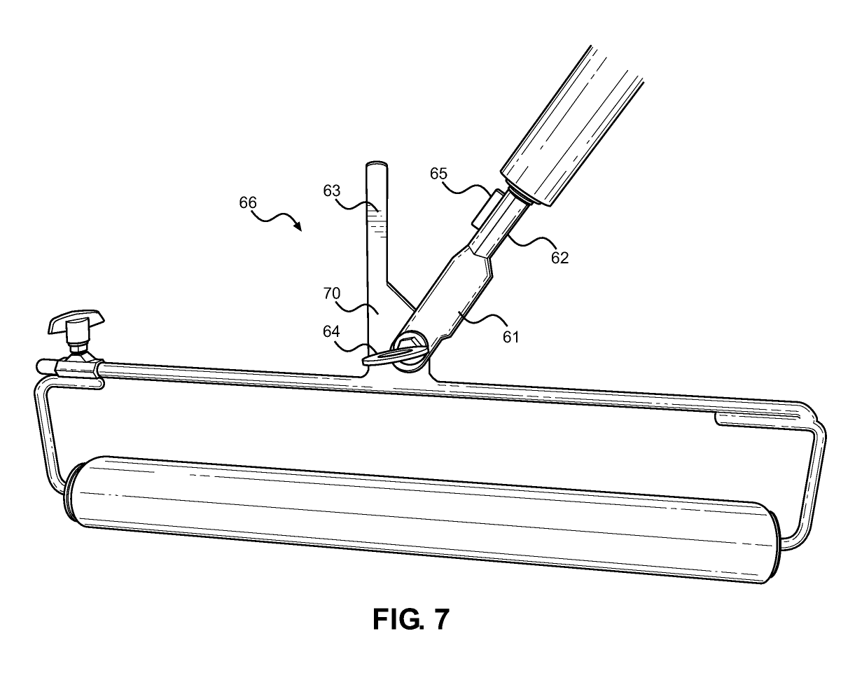

Referring now to FIGS. 6 and 7, there are shown front views of the third embodiment of the epoxy and paint roller 66 of the present invention. The illustrated embodiment comprises an elongated roller support 52 having a first end 58 and a second end 59. The second end 59 of the roller support 52 is affixed to a first brace 54 that rotatably connects to a roller 53. The first end 58 of the roller support 52 comprises a second brace 55 that is adjustably connected thereto via a brace connector 56 integral thereto. The brace connector 56 is substantially cylindrical in shape and comprises an opening so as receive a portion of the roller support 52 therethrough. In this way, the brace connector 56 is slideably attached to the roller support 52 at the first end 58 thereof. The brace connector 56 comprises a fastener 57 thereon. The fastener 57 can be loosened or tightened to adjust the position of the second brace 55. In this way, the roller support 52 can be used with rollers 53 of various lengths and sizes.

The roller support 52 further comprises a handle locking member 70 having an elongated arm 63. The handle locking member 70 is attached to a pivoting member 61 via a fastener 64, such as a screw or the like. The pivoting member 61 includes a metallic arm 62 having a magnet 65 thereon. The upper end of the metallic arm 62 is connected to a handle connector 67, which comprises threaded elements therein so as to removably connect to an elongated handle.

In use, the magnet 65 of the pivoting member 61 is attached to the handle locking member 70 so that in a first position, the pivoting member 61 and the handle connector 67 are perpendicular to the roller support 52, and in a second position, the pivoting member 61 and the handle connector 67 are moved to an angle relative to the roller support 52. In the first position, the magnet 65 is removably engaged with the elongated arm 63 of the handle locking member 70 so as to lock the pivoting member 61 and the handle connector 67 in place. The elongated arm 63 prevents the pivoting member 61 from pivoting beyond the handle locking member 70. In this way, pivoting member 61 and the handle connector 67, and in turn, the handle, can be oriented such that they are substantially parallel to the roller support 52. When the handle is in the first position, the roller can be rolled up and down. When the handle is in the second position, the roller can be rolled side to side. Thus, the present invention allows the user to move the roller side to side or up and down without adjusting his or her grip.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An epoxy and paint roller, comprising:
an adjustable handle having a distal end and a working end;
said working end having a knuckle joint pivotally connected to a roller support;
said roller support rotatably supporting a roller via at least one L-shaped brace.

2. The epoxy and paint roller of claim 1, wherein said handle is adapted to move from one side of an axis of said roller to an opposite side of said axis of said roller.

3. The epoxy and paint roller of claim 1, wherein said at least one L-shaped brace comprises a first L-shaped brace and a second L-shaped brace;
said first L-shaped brace rotatably attached to a first end of said roller;
said second L-shaped brace rotatably attached to a second end of said roller.

4. The epoxy and paint roller of claim 3, wherein said roller support comprises a closed loop centrally located thereon;
said closed loop having a slanted upper edge with a first magnet thereon;
said knuckle joint having a second magnet thereon;
wherein said first magnet and said second magnet are adapted to removably secure said handle in place so that said handle is perpendicular to said roller support.

5. The epoxy and paint roller of claim 1, said roller support having at least one channel for guiding a fastener therealong;
wherein said fastener is connected to said at least one L-shaped brace and said fastener can be loosened or tightened to adjust the position of said at least one L-shaped brace along said channel.

6. The epoxy and paint roller of claim 5, wherein said at least one L-shaped brace comprises a tab that is configured to removably insert into a hollow cavity of said roller.

7. An epoxy and paint roller, comprising:
an adjustable handle having a distal end and a working end;
said working end having a pivoting member pivotally connected to a handle locking member of a roller support;
said roller support rotatably attached to a roller via at least one L-shaped brace.

8. The epoxy and paint roller of claim 7, wherein said at least one L-shaped brace comprises a first L-shaped brace and a second L-shaped brace;
said first L-shaped brace attached to a first end of said roller support;
said second L-shaped brace slideably attached to a second end of said roller support.

9. The epoxy and paint roller of claim 7, wherein said pivoting member comprises a magnet that can attach to said handle locking member so that said handle can be temporarily locked in a position perpendicular to said roller support.
